(19) United States
(12) Patent Application Publication
(10) Pub. No.: US 2015/0362340 A1
(43) Pub. Date: Dec. 17, 2015

(54) Position sensor, sensor arrangement and lithography apparatus comprising position sensor

(71) Applicant: Carl Zeiss SMT GmbH, Oberkochen (DE)

(72) Inventor: Anton Montagne, EP Delft (NL)

(21) Appl. No.: 14/834,561

(22) Filed: Aug. 25, 2015

Related U.S. Application Data
(63) Continuation of application No. PCT/EP2014/055138, filed on Mar. 14, 2014.
(60) Provisional application No. 61/782,101, filed on Mar. 14, 2013.

(30) Foreign Application Priority Data
Mar. 14, 2013 (DE) 102013204494.1

(51) Int. Cl. G01D 5/22

(52) U.S. Cl. CPC G01D 5/2275

(57) ABSTRACT

A position sensor for detecting a position of a measurement object, in particular of an optical element of a lithography apparatus is suggested, which includes a transmission coil, a reception coil, which is arranged in such a way that when a transmission signal (Vt, It) is applied to the transmission coil, a reception voltage (Vz, Vx) is generated at the reception coil, and an evaluation device, which links a transmission voltage signal generated in a manner dependent on the transmission signal with a reception voltage signal generated in a manner dependent on the reception voltage and generates a sensor output signal containing information about the relative position of the measurement object with respect to the coils of the position sensor.

### CROSS-REFERENCE TO RELATED APPLICATIONS

The present application is a continuation of, and claims benefit under 35 USC 120 to, international application PCT/EP2014/055138, filed Mar. 14, 2014, which claims benefit under 35 USC 119 of German Application No. 10 2013 204 494.1, filed Mar. 14, 2013. International application PCT/EP2014/055138 also claims priority under 35 USC 119(e) to U.S. Provisional Application No. 61/782,101, filed Mar. 14, 2013. The entire disclosure of each of International application PCT/EP2014/055138 and German Application No. 10 2013 204 494.1 is incorporated by reference herein.

### FIELD OF THE INVENTION

The invention relates to a position sensor for detecting a relative position of a measurement object, in particular of an optical element of a lithography apparatus, and to a sensor arrangement and to a lithography apparatus comprising such a position sensor.

### RELATED ART

Lithography apparatuses are used, for example, during the production of integrated circuits or ICs in order to image a mask pattern in a mask onto a substrate, such as e.g. a silicon wafer. In this case, a light beam is generated by a light source. In the case of EUV (with wavelengths in the range of 5 nm-30 nm), this can be a plasma source, a synchrotron source or else a free electron laser. In the case of VUV or DUV, the light source can be an excimer laser, and an arc lamp in the case of I-line. The light generated by the light source is transformed by an illumination system such that both field and pupil on the mask to be imaged are filled, wherein the pupil forms chosen can be different in accordance with the structures to be imaged. The light reflected by the mask bears the information about the structures to be imaged, which are imaged onto the silicon substrate (wafer) via a projection lens. In the case of EUV, the short wavelengths mentioned make it possible to image tiny structures on the wafer. Since light in this wavelength range is absorbed by atmospheric gases, the beam path of such EUV lithography apparatuses is situated in a high vacuum. Furthermore, there is no material which is sufficiently transparent in the wavelength range mentioned, for which reason mirrors are used as optical elements for shaping and guiding the EUV radiation.

The individual mirrors and other optical elements should be positioned as exactly as possible with regard to their orientation, since even small deviations of the position of the mirrors can lead to the imaged structures being impaired, which can lead to defects in the integrated circuits produced. In order to monitor and, if appropriate, readjust the position of the individual mirrors, the lithography apparatus is provided with position sensors that detect the position and orientation of the mirrors, that is to say the position of the mirrors with respect to the six degrees of freedom (three translational and three rotational). Depending on the design of the lithography apparatus, it is also possible for fewer than six degrees of freedom to be actuated and, consequently, for correspondingly fewer sensor axes to be required.

The requirements made of the position sensors are very high. Firstly, their resolution and drift stability must be high enough to make possible, via a closed control loop, a sufficient positional stability in the controlled degrees of freedom of the optical element. Furthermore, they should be compact, since the space in the mirror optical unit of the lithography apparatus is very limited. Particularly in the case of adaptive optical elements that usually consist of a multiplicity of actuated elements closely strung together, sensors are required which can be close packed on a regular grid. Furthermore, the sensors should be suitable for vacuum, in order to be able to be accommodated in the vacuum region of the lithography apparatus. Finally, they should be robust toward high temperatures such as can occur near the radiation path of the lithography apparatus.

It is possible to use capacitive displacement sensors for detecting the position or the displacement of optical elements in a lithography apparatus. The basic principle of such capacitive displacement sensors consists in providing one or a plurality of metal strips provided opposite a metal strip on a measurement object. The capacitance formed by the metal strips lying opposite one another changes in the event of a displacement of the measurement object in the plane of the metal strips. By measuring the capacitance, it is thus possible to deduce the position of the measurement object.

However, the power of the measurement signal of such a capacitive displacement sensor is generally very small and therefore has a comparatively small signal-to-noise ratio. In some types of capacitive sensors, the capacitance is greatly dependent on the distance between the metal strips lying opposite one another, that is to say on the position of the measurement object perpendicular to the plane of the metal strips. Finally, it is difficult to use a displacement sensor to detect the position of the measurement object with regard to more than one degree of freedom, since this requires a complex and voluminous arrangement of the metal strips.

U.S. Pat. No. 6,483,295B2 describes an inductive position sensor comprising an oscillator circuit, which generates a periodic AC voltage signal and couples it into an excitation coil, comprising a plurality of reception coils, wherein the excitation coil and the reception coils are embodied as conductor tracks on a carrier board, and comprising an evaluation circuit for evaluating the signals induced in the reception coils, and a movable inductive coupling element, which influences the strength of the inductive coupling between the excitation coil and the reception coils. In this case, the evaluation circuit is arranged within the geometry of the transmission and/or reception coils and the effective areas of the reception coils in the beginning and/or end region of the sensor are embodied in such a way that when the movable element is not present, the summation voltage of zero arises at the taps of the reception coils. The arrangement in the document does not take into account, however, the fact that the reception voltage induced in the reception coil is not only dependent on the position of the measurement object in the measurement direction (that is to say in a shear direction), but also greatly dependent on the distance between the measurement object and the position sensor, that is to say on the distance of the measurement object in the direction with respect to the coil axis. Consequently, the arrangement disclosed in the document is suitable only for cases in which the distance between the measurement object and the position sensor is fixedly defined, e.g. via a corresponding mounting. By contrast, the arrangement is unsuitable for cases in which the distance between the measurement object and the position sensor is unknown or variable.

Document DE 697 17 188 T2 describes a varying magnetic field position and movement detector. The detector determines the position and movement of a part that contains at least a metallic section. The device comprises a primary coil which induces a magnetic field and two secondary coils to detect the magnetic field. The two secondary coils are contained within the plane so that they are parallel to the plane of the part and have a differential structure with respect to the primary coil. The part has zones of weak and strong magnetic permeability, so that the fields induced at the secondary coils are modified by the presence of zones of weak and strong permeability so that the speed or position of the part may be determined.

Document US 2009/0309578 A1 shows sensor inductors, sensors for monitoring movements and positioning, apparatus, systems and methods therefore. The planar shaped inductor is particularly adaptable for use in motion or position sensors. One inductor can function as a signal input unit and another as a pick up unit in an arrangement wherein both inductors are placed in a generally parallel juxtaposition for flux flow there between. A movable armature is located between the inductors to control the amount of flux transmission between inductors. The position of the armature relative to the inductors controls the output signal generated by the pickup inductor that are adapted to be converted into indications of displacements.

Document US 2007/0001666 A1 describes a linear and rotational inductive position sensor. The position sensor is configured to provide a signal related to a position of a part including an exciter coil, and a receiver coil disposed proximate to the exciter coil. The exciter coil generates magnetic flux when the exciter coil is energized by a source of electrical energy, such as an alternating current source. The receiver coil generates a receiver signal when the exciter coil is energized, due to an inductive coupling between the receiver coil and the exciter coil. The receiver coil has a plurality of sections, the inductive coupling tending to induce opposed voltages in at least two of the sections.

Consequently, one object of the present invention is to provide a compact and precise position sensor which meets the requirements mentioned above. In particular, one object is to provide a position sensor with which a displacement of a measurement object in a shear direction can be detected precisely even if the distance between the measurement object and the position sensor is unknown or variable. A further object is to provide a position sensor with which the position of a measurement object, such as e.g. an optical element of a lithography apparatus, can be detected with respect to more than one degree of freedom in a simple manner.

### BRIEF SUMMARY OF THE INVENTION

At least one of the objects is achieved—via a position sensor for detecting a position of a measurement object, in particular of an optical element of a lithography apparatus, comprising a transmission coil and a reception coil, which are arranged on different parallel planes of a printed circuit board, wherein the transmission coil and the reception coil are arranged in such a way that when a temporally variable transmission signal is applied to the transmission coil, a temporally variable reception signal is generated at the reception coil, wherein the ratio of reception signal to transmission signal contains information about the relative position of the measurement object with respect to the reception coil.

Providing the transmission coil and a reception coil on a printed circuit board makes it possible to produce a precise and compact position sensor cost-effectively. Furthermore, there is a high degree of freedom for the layout of the transmission coil and of the reception coil. The “different parallel planes of a printed circuit board” can be the front and rear sides of the printed circuit board, or else planes arranged there between parallel thereto within the printed circuit board. The transmission signal can be a transmission voltage or a transmission current. The reception signal is typically a reception voltage.

In this case, the reception coil has a first reception coil section and a second reception coil section, wherein the first reception coil section and the second reception coil section are connected to one another in such a way that when the transmission signal is applied to the transmission coil, a reception voltage is generated at the reception coil,—the reception voltage corresponding to a difference between the voltage at the first reception coil section and the voltage at the second reception coil section. In other words, the first and the second reception sections can therefore be connected in antiseries with one another, as a result of which it is possible to realize a differential sensor arrangement which responds very sensitively to changes in the position of the measurement object.

The first reception coil section and the second reception coil section are arranged on different parallel planes of the printed circuit board and are connected to one another in such a way that the transfer response of transmission coil and reception coil contains information about the position of the measurement object in a distance direction relative to the reception coil. A compact distance sensor can be realized in this way. In this case, the first reception coil section and the second reception coil section can be arranged on different sides of the transmission coil. In other words, the transmission coil and the first and second reception coil sections can be arranged, for example, on three substantially parallel planes, wherein the transmission coil is arranged between the first and second reception coil sections. Consequently, the distance sensor is more sensitive than when both reception coil sections are arranged on the same side of the transmission coil. The transfer response of transmission coil and reception coil may include or may be the transfer function.

The first reception coil section and the second reception coil section can be arranged in such a way that when a transmission voltage is applied to the transmission coil in the absence of the measurement object, substantially no voltage is present at the reception coil.

Particularly if the position sensor is designed as a distance sensor, the first reception coil section and the second reception coil section can be substantially congruent with the transmission coil. In this case, “congruent” can mean that the reception coil section have substantially (that is to say with deviations of not greater than 20%, preferably not greater than 10%) the same dimensions as the transmission coil. Particularly if the position sensor is designed as a shear sensor, the first reception coil section and the second reception coil section can each have substantially half of the area extent of the transmission coil. It is thus possible to achieve a high degree of coupling between transmission and reception coils in conjunction with a compact arrangement.

In one possible embodiment, a first and a second reception coil are provided, which each have a first and a second reception coil section, wherein the first and the second reception coil sections are in each case connected to one another in such a way that when the transmission signal is applied to the transmission coil, a reception signal is in each case generated at the first and second reception coils, wherein the ratio of reception signal to transmission signal contains information about the position of the measurement object in a shear direction relative to the reception coil. Consequently, two shear sensor signals are thus generated, such that a particularly precise measurement is made possible for example by averaging these sensor signals.

In a further possible embodiment, the position sensor comprises a plurality of reception coil sections, and a switch element having a first and a second switch position, wherein the reception coil sections are interconnected to form a first reception coil in the first switch position in such a way that when a transmission signal is applied to the transmission coil, a first reception signal is generated at the first reception coil, wherein the ratio of the first reception signal to the transmission signal contains information about the position of the measurement object in a shear direction relative to the first reception coil, and wherein the reception coil sections are interconnected to form a second reception coil in the second switch position in such a way that when a transmission signal is applied to the transmission coil, a second reception voltage is generated at the second reception coil, wherein the ratio of the second reception signal to the transmission signal contains information about the position of the measurement object in a distance direction relative to the second reception coil. In accordance with this embodiment, the position sensor can optionally be operated as a shear sensor or as a distance sensor. Depending on the switching state, the reception signal in this case correlates more strongly with displacements of the measurement object in a distance direction or with displacements of the measurement object in a shear direction.

In a further possible embodiment, the position sensor comprises a first and a second reception coil, which are designed in such a way that when a transmission signal is applied to the transmission coil, a first reception signal is generated at the first reception coil, wherein the ratio of the first reception signal to the transmission signal contains information about the position of the measurement object in a shear direction relative to the first reception coil, and when a transmission signal is applied to the transmission coil, a second reception voltage is generated at the second reception coil, wherein the ratio of the second reception signal to the transmission signal contains information about the position of the measurement object in a distance direction relative to the second reception coil. Consequently, it is possible to provide a position sensor which, with a compact arrangement, can detect the position of a measurement object with respect to a plurality of degrees of freedom. In the embodiments described above, the first reception coil and the second reception coil can be arranged on different sides of the transmission coil.

The position sensor can furthermore comprise a drive device, which applies an alternating transmission signal to the transmission coil, and an evaluation device, which evaluates the reception signal at the reception coil. The drive device and the evaluation device can be arranged on the same printed circuit board as the transmission coil and the reception coil, or on different printed circuit boards. If the drive device and the evaluation device are arranged on a different printed circuit board from the transmission coil and the reception coil, then a particularly compact arrangement can be obtained if the printed circuit boards are connected to one another in a planar manner, wherein a metal film is provided between the printed circuit boards. In this case, the metal film constitutes a barrier for parasitic inductive and capacitive coupling between the transmission and reception coils of the printed circuit board, on the one hand, and the drive and evaluation devices, on the other hand. Providing the metal film therefore ensures that the position measurement is not influenced and thus corrupted by parasitic coupling between coils and drive and evaluation devices.

In accordance with a further aspect of the invention, a position sensor for detecting a position of a measurement object, in particular of an optical element of a lithography apparatus, comprises a transmission coil, a reception coil, which is arranged in such a way that when a transmission signal is applied to the transmission coil, a reception voltage is generated at the reception coil, and an evaluation device, which links a transmission voltage signal generated in a manner dependent on the transmission signal with a reception voltage signal generated in a manner dependent on the reception voltage and generates a sensor output signal containing information about the relative position of the measurement object with respect to the coils of the position sensor. In this case, the transmission voltage signal is dependent on the distance between the position sensor and the measurement object. Consequently, it is possible to provide a position sensor with which a displacement of a measurement object in a shear direction can be detected precisely even if the distance between the measurement object and the position sensor is unknown or variable.

In one possible configuration, the evaluation device comprises a first analog-to-digital converter, which converts the voltage generated by the reception coil or an analog signal derived therefrom into a digital signal, and a second analog-to-digital converter, which converts the voltage present at the transmission coil or an analog signal derived therefrom into a digital signal.

The evaluation device can form, for example, a cross-correlation of the transmission signal with the reception signal. As an alternative thereto, the evaluation device can have a memory in which a look-up table is stored, which assigns the values of the transmission signal and of the reception signal to an output value representing the position of the measurement object relative to the position sensor. Consequently, it is possible to correct the shear sensor signal with regard to displacements of the measurement object in the distance direction.

The transfer function H(ω) of a transformer describes the ratio of the output voltage amplitude to the transmission voltage amplitude as a function of the excitation frequency ω:

$$H ( ω ) = \frac{{V}_{out} ( ω )}{{V}_{i n} ( ω )}$$

For non-periodic temporally variable input signals such as white noise, for example, it is possible to determine the transfer function in a generalized form via the autocorrelation and the cross-correlation functions or from the corresponding auto and cross power densities of the input and output voltages:

$$H ( ω ) = \frac{{S}_{out , i n} ( ω )}{{S}_{i n , i n} ( ω )}$$

The position sensor can furthermore comprise a drive device, which applies an alternating transmission signal to the transmission coil. In one possible configuration, in this case, the drive device can vary the transmission signal in a manner dependent on a sensor output signal. Consequently, the transmission signal can be adapted to the distance of the measurement object, and the influence of the distance of the measurement object on the sensor signal can be suppressed.

Furthermore, the drive device can have an impedance matching network. The reactive power that is output can thus be reduced. In one possible configuration, the impedance matching network can have an adjustable capacitor which is adjustable in a manner dependent on the sensor output signal. Consequently, the transmission signal can be adapted to the distance of the measurement object.

Furthermore, it is possible, in a sensor arrangement, to arrange a plurality of the above-described position sensors alongside one another. In this case, the position sensors can be arranged into a series alongside one another or else in a two-dimensional array. In this case, it can be provided that transmission signals having different frequencies can be applied to adjacent position sensors. Crosstalk between adjacent position sensors can thus be suppressed.

Further exemplary embodiments will be explained with reference to the accompanying drawings.

### BRIEF DESCRIPTION OF THE DRAWINGS

FIG. 1A schematically shows an arrangement of the transmission coil and of the reception coil of a position sensor in accordance with a first embodiment;

FIG. 1B schematically shows the sequence of the layers of the transmission coil and of the reception coil on and in a printed circuit board in the position sensor in accordance with the first embodiment;

FIG. 2 schematically shows a section through the position sensor in accordance with the first embodiment and an exemplary arrangement of the position sensor relative to the measurement object;

FIG. 3A schematically shows an arrangement of the transmission coil and of the reception coil of a position sensor in accordance with a second embodiment;

FIG. 3B schematically shows the sequence of the layers of the transmission coil and of the reception coil on and in a printed circuit board in the position sensor in accordance with the second embodiment;

FIG. 4A schematically shows an arrangement of the transmission coil and of the reception coil of a position sensor in accordance with a third embodiment;

FIG. 4B schematically shows the sequence of the layers of the transmission coil and of the reception coil arrangement on and in a printed circuit board in the position sensor in accordance with the third embodiment;

FIG. 5 schematically shows an exemplary arrangement of the transmission coil and the reception coils in a position sensor in accordance with the third embodiment,—the position sensor being interconnected as a shear sensor;

FIG. 6 schematically shows an exemplary arrangement of the transmission coil and the reception coil in a position sensor in accordance with the third embodiment,—the position sensor being interconnected as a distance sensor;

FIG. 7 shows a variant of the position sensor in accordance with the third embodiment, which can optionally be operated as a shear sensor or as a distance sensor;

FIG. 8A schematically shows an arrangement of the transmission coil and of the reception coil of a position sensor in accordance with a fourth embodiment;

FIG. 8B schematically shows the sequence of the layers of the transmission coil and of the reception coils on and in a printed circuit board in the position sensor in accordance with the fourth embodiment;

FIG. 9 shows a position sensor together with evaluation electronics in accordance with a fifth embodiment;

FIG. 10 shows a variant of the position sensor in accordance with the fifth embodiment;

FIG. 11 shows a position sensor in accordance with a sixth embodiment;

FIG. 12 shows a further development of the position sensor in accordance with the sixth embodiment; and

FIG. 13 shows one possible embodiment of the drive device of the position sensor.

### EMBODIMENTS OF THE INVENTION

Unless indicated otherwise, identical reference signs in the figures designate identical or functionally identical elements. Furthermore, it should be noted that the illustrations in the figures are not necessarily true to scale.

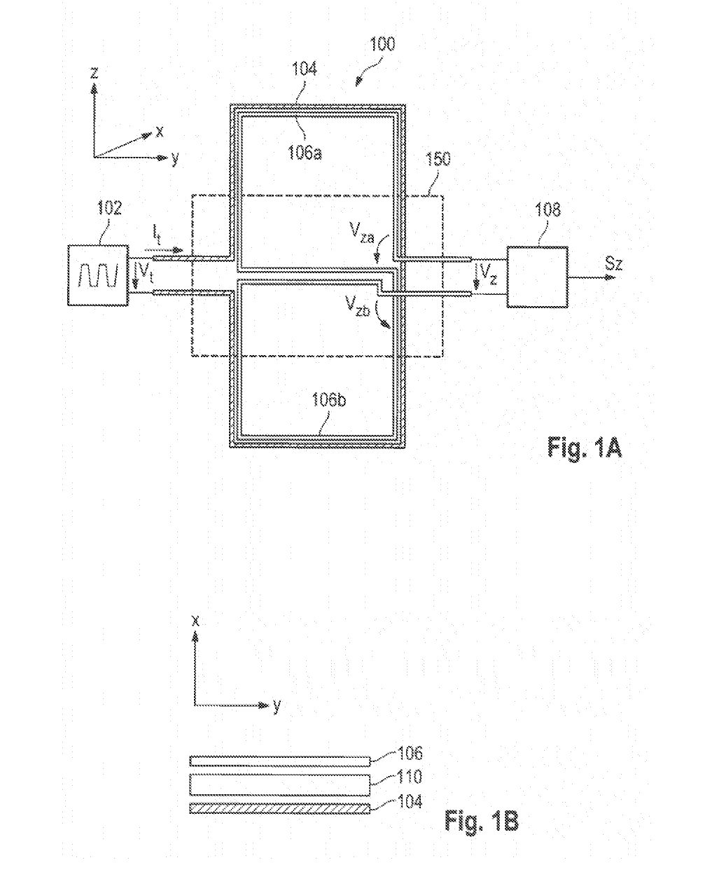

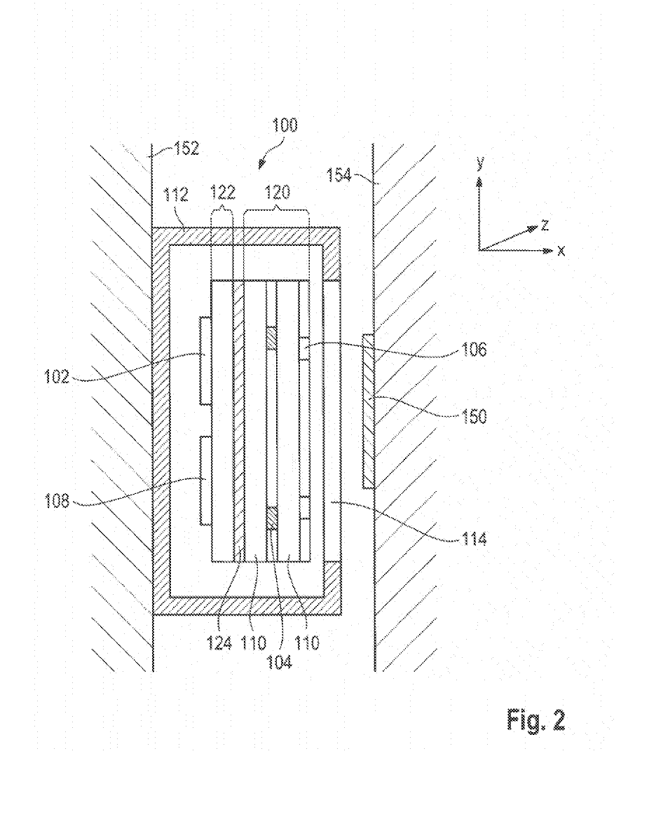

The principle of a differential inductive position sensor 100 in accordance with a first exemplary embodiment is explained below with reference to FIGS. 1A, 1B and 2. The position sensor 100 comprises a drive device 102, a transmission coil 104, a reception coil 106 and an evaluation device 108. FIG. 1A schematically shows an exemplary arrangement of the transmission coil 104 and of the reception coil 106 and the connection thereof to the drive device 102 and to the evaluation device 108. FIG. 1B schematically shows the sequence of the layers of the transmission coil 104 and of the reception coil 106 on and in a printed circuit board.

The transmission coil 104 and the reception coil 106 are arranged on different planes of a printed circuit board. By way of example, the transmission coil 104 can be arranged on one side (first plane) and the reception coil 106 can be arranged on the other side (second plane) of a printed circuit board, wherein the transmission coil 104 and the reception coil 106 be electrically isolated by an insulating layer 110 of the printed circuit board, as is indicated in FIG. 1B. The transmission coil 104 and the reception coil 106 are each of rectangular design and can have dimensions of 5×10 mm, for example. The transmission coil 104 and the reception coil 106 can be embodied as metallic conductor tracks having a width of e.g. 0.2 mm, e.g. composed of copper or the like, on the printed circuit board, which enables relatively simple industrial production. It should be noted that the different parallel planes of the printed circuit boards are identified by different gray shades in the figures. In this case, the planes or conductor tracks are depicted lighter, the nearer they are to the measurement object. A crossover is present in the reception coil 106 in FIG. 1A; at this location, bridging with a wire bridge or the like can take place, or, as an alternative thereto, at this location, the reception coil 106 can be led on a different conductor track plane in a locally delimited manner using a via.

In the example illustrated in FIG. 1A, the transmission coil 104 comprises a looped conductor track, which is connected to the drive device 102 at both of its ends. The reception coil 106 comprises a first reception coil section 106a and a second reception coil section 106b. The reception coil sections 106a and 106b have approximately half of the extent of the transmission coil 104 and together approximately cover the transmission coil 104. One end in each case of the first and the second reception coil sections 106a, 106b is connected to the evaluation device 108. In this case, a voltage V_{z} (reception signal) is present between these ends of the reception coil sections 106a and 106b, that is to say at the ends of the reception coil 106. The other two ends of the reception coil sections 106a and 106b are connected to one another, to be precise in such a way that the reception coil sections 106a and 106b are connected in antiseries with one another, as will be explained in even greater detail below.

It should be noted that in this case “coil” can be understood to mean a conductor arrangement which is substantially looped, that is to say for example a conductor arrangement running in sections in the +y-direction, +z-direction, −y-direction, and −z-direction. These conductor sections can be arranged in one plane, namely the coil plane, on or in the printed circuit board to which the coil axis is perpendicular.

The drive device 102 applies a temporally variable transmission voltage Vₜ (transmission signal) to the transmission coil 104. The temporally variable transmission voltage Vₜ can be, for example, an AC voltage of 1V and having a frequency of 1 MHz. There is no particular restriction with regard to the waveform of the AC voltage Vₜ, and the latter can be, for example, sinusoidal, pulsed or the like. A sinusoidal AC voltage is advantageous, however, with regard to the suppression of high-frequency components. On account of this AC voltage, an AC current Iₜ (transmission current) flows through the transmission coil 104, which current has the effect that the transmission coil 104 generates a magnetic field that is strongest in the direction of the coil axis (that is to say in the x-direction in the figures). In the coil plane, the magnetic field is oriented perpendicularly to the plane. The magnetic field is an alternating magnetic field whose frequency corresponds to the frequency of the AC voltage Vₜ. On account of this alternating magnetic field, a voltage V_{za} and V_{zb} is respectively induced in the reception coil sections 106a and 106b. On account of the antiseries connection of the reception coil sections 106a and 106b, the voltages V_{za} and V_{zb} mutually cancel one another out, such that overall the difference voltage V_{z}=V_{za}−V_{zb} is present at the reception coil 106. If the arrangement comprising transmission coil 104 and reception coil 106 is substantially symmetrical and no further metallic articles are situated in the vicinity, then the difference voltage is substantially V_{z}=0.

The arrangement described here makes it possible to detect the position of an electrically conductive measurement object 150. The measurement object 150 can be a metal strip, for example, which is arranged substantially parallel to the coils 104, 106. It is also possible for the measurement object 150 to consist of a doped semiconductor or the like. In a basic position, the measurement object 150 is arranged symmetrically with respect to the two reception coil sections 106a and 106b and in this case covers, as viewed from above (that is to say in the x-direction), an identical area proportion of the reception coil sections 106a and 106b. In the conductive measurement object 150, the magnetic field generated by the transmission coil 104 induces an eddy current that in turn generates an opposite magnetic field. The measurement object 150 therefore to an extent reflects the magnetic field generated by the transmission coil 104. The resulting total magnetic field passing through the reception coil sections 106a and 106b is therefore correspondingly smaller, with the result that the voltages V_{za} and V_{zb} induced in the reception coil sections 106a and 106b are also reduced. This reduction of the voltages V_{za} and V_{zb} corresponds to the extent to which the reception coil sections 106a and 106b are covered by the measurement object 150. As already indicated above, the measurement object 150 in its basic position substantially covers the same area proportion of the reception coil sections 106a and 106b, with the result that the reception voltage V_{z} is substantially zero. However, if the measurement object 150 is displaced parallel to the reception coils 106a and 106b (to put it more precisely in the z-direction), then it covers different area proportions of the reception coil sections 106a and 106b, with the result that the reception voltages V_{za} and V_{zb} differ. A reception voltage V_{z} different from zero thus results,—the reception voltage being present at the reception coil 106, wherein the amplitude of—the reception voltage V_{z} corresponds to the displacement of the measurement object 150 in the z-direction relative to the reception coil sections 106a and 106b. Furthermore, from the phase of the reception voltage V_{z} it is possible to derive whether the measurement object 150 was displaced in the z-direction or −z-direction. Furthermore, the ratio of reception signal (reception voltage V_{z}) to transmission signal (transmission voltage Vₜ) contains information about the relative position of the measurement object 150 with respect to the reception coil 106.

This position sensor 100 therefore functions as a shear sensor, wherein at the reception coil 106 a reception voltage V_{z} is generated which is lower than the voltages V_{za} and V_{zb} respectively generated at the reception coil sections 106a and 106b and which contains information about the relative position of the measurement object 150 in a shear direction (z-direction), with respect to the reception coil 106. Furthermore, the position sensor 100 is designed as a differential sensor, which therefore enables a more precise measurement result than a position sensor having only one reception coil.

The evaluation device 108 evaluates the reception voltage V_{z} and can demodulate and digitize the reception voltage V_{z}, for example, as will also be described in detail further below. The evaluation device 108 can output a digital signal Sz, for example, which represents the displacement of the measurement object 150 in a shear direction (z-direction) relative to the reception coil 106.

It should be noted that the measurement object 150 need not necessarily be strip-shaped. Rather, it suffices if, on account of the magnetic field generated by the transmission coil 104, an eddy current that generates a magnetic field in the opposite direction can be induced in the measurement object 150. The measurement object 150 can therefore also be embodied in a ring-shaped fashion, for example. However, a strip-shaped measurement object 150 enables a precise sensor arrangement.

FIG. 2 schematically shows a section through the position sensor 100 and an exemplary arrangement of the position sensor 100 relative to the measurement object 150. As is illustrated in FIG. 2, the drive device 102, the transmission coil 104, the reception coil 106 and the evaluation device 108 are arranged within a housing 112 of the position sensor 100. The housing 112 can, for example, be in the form of a box or the like and be fixed (e.g. screwed) to a positionally fixed frame element 152. The housing 112 can be produced e.g. from metal, such as e.g. aluminum or the like, such that shielding against external magnetic fields is achieved. In the housing 112, a window 114 is provided at the side facing away from the frame element 152. The window 114 can consist for example of a ceramic material, such as Al₂O₃, for example, which is permeable to magnetic fields. In principle, all non-conductors, such as glass, for example, in particular quartz glass, or circuit board material (e.g. FR-4), are possible as material for the window 114. In this case, the window 114 is arranged in such a way that the magnetic field generated by the transmission coil 104 can pass through the window 114, be reflected at the measurement object 150 and, passing through the window 114 again, reach the reception coil 106.

The transmission coil 104 and the reception coil 106 are arranged on or in a first printed circuit board 120, whereas the drive device 102 and the evaluation device 108 are arranged on a second printed circuit board 122. The first printed circuit board 120 and the second printed circuit board 122 are separated from one another by a thin metal film 124 (e.g. composed of aluminum). This ensures that leakage fields emerging from the drive device 102 and the evaluation device 108 do not influence the reception voltage V_{z} and thus the measurement result. Furthermore, a very compact and flat arrangement is thus achieved.

The drive device 102 and the evaluation device 108 are connected to the transmission coil 104 and the reception coil 106 for example via flexible lines led outside the printed circuit boards or via (correspondingly insulated) through-holes in the printed circuit boards 120, 122 and the metal film 124. Furthermore, the drive device 102 and the evaluation device 108 are connected to an external control device or the like via lines (not illustrated in more specific detail) through holes in the housing 112. In this case, the housing 112 can be closed in an air-tight fashion, such that the position sensor 100 is suitable in particular for use in high-vacuum environments (e.g. in EUV lithography apparatuses or the like).

As is illustrated in FIG. 2, the measurement object 150 embodied as a metal strip can be fixed to a structural element 154. By way of example, the structural element 154 can be an optical element, that is to say a mirror, for example, in an EUV lithography apparatus, wherein the strip-shaped measurement object 150 is fixed to the surface of the optical element 154. Consequently, the displacement of the optical element 154 relative to the positionally fixed frame element 152 can be detected with the aid of the position sensor 100. By providing a plurality of the position sensors 100, it is furthermore possible to detect the position of the optical element 154 with respect to all six degrees of freedom. Crosstalk between the different position sensors can be avoided in this case by the individual position sensors being operated at different frequencies.

The position sensor 100 can be designed to be very compact and flat. Since the transmission coil 104 and the reception coil 106 are arranged in different planes of the printed circuit board 120, there is a high degree of freedom with regard to the layout of the transmission coil 104 and the reception coil 106. In particular, the transmission coil 104 and the reception coil 106 can be designed in such a way that they have substantially the same area extent and are provided near one another in a manner overlapping one another. Consequently, a high degree of coupling between the transmission coil 104 and the reception coil 106 can be achieved even in the case of a compact layout. Since the transmission coil 104 and the reception coil 106 are provided on or in a printed circuit board 120, they can be produced cost-effectively and with extremely high precision.

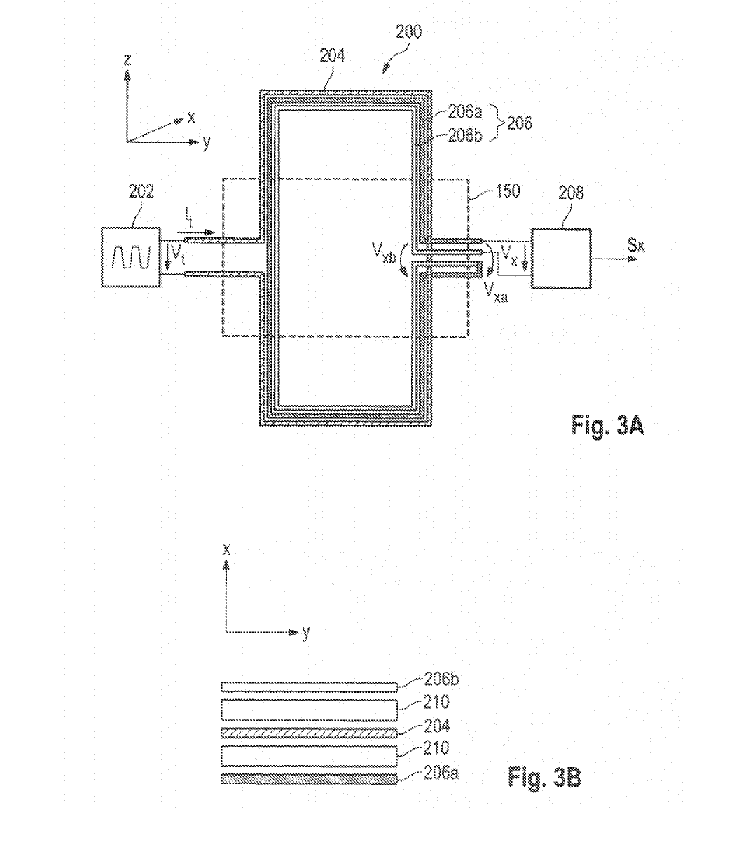

A position sensor 200 in accordance with a second embodiment is explained below with reference to FIGS. 3A and 3B, the position sensor comprising a drive device 202, a transmission coil 204, a reception coil 206 and an evaluation device 208. This position sensor 200 is designed as a differential distance sensor. FIG. 3A schematically shows an exemplary arrangement of the transmission coil 204 and of the reception coil 206. FIG. 3B schematically shows the sequence of the layers of the transmission coil 204 and of the reception coil 206 on and in a printed circuit board. Unless explained otherwise, the drive device 202, the transmission coil 204, the reception coil 206 and the evaluation device 208 correspond functionally and structurally to the drive device 102, the transmission coil 104, the reception coil 106 and the evaluation device 108 in the first embodiment, and primarily the differences between these embodiments are discussed below.

In the embodiment illustrated in FIG. 3A, too, the transmission coil 204 comprises a looped conductor track connected to the drive device 202 at both of its ends. The reception coil 206 comprises a first reception coil section 206a and a second reception coil section 206b. In this case, the reception coil sections 206a and 206b have approximately the same extent as viewed from above, that is to say are illustrated as nested one in the other only for illustrative reasons in FIG. 3A. Furthermore, the reception coil sections 206a and 206b can also have approximately the same extent as the transmission coil 204, as viewed from above. The same correspondingly also applies to the embodiments discussed below.

FIG. 3B schematically shows the sequence of the layers of the transmission coil 204 and of the reception coil sections 206a and 206b on and in a printed circuit board. The reception coil sections 206a and 206b are arranged parallel to one another on opposite sides of the transmission coil 204. In this case, the transmission coil 204 and the reception coil sections 206a and 206b are separated from one another in each case by an insulating layer 210 of the printed circuit board.

One end in each case of the first and the second reception coil sections 206a, 206b is connected to the evaluation device 208. A reception voltage Vₓₐ and V_{xb} is respectively present at the ends of the reception coil sections 206a and 206b. In this arrangement, too, on account of the antiseries connection of the reception coil sections 206a and 206b, at the reception coil 206 overall a difference voltage Vₓ=Vₓₐ−V_{xb} is present which is lower than the reception voltage Vₓₐ and V_{xb} at the individual reception coil sections 206a and 206b, respectively. If the arrangement comprising transmission coil 204 and reception coil 206 is substantially symmetrical and there are no further metallic articles or the measurement object in the vicinity, then the difference voltage is substantially Vₓ=0.

If the measurement object 150 is then brought near to the position sensor 200 from the side of the reception coil section 206b, the self-inductances of the reception coil sections 206a and 206b are then altered. In this case, the self-inductance of the reception coil section 206b changes more than the self-inductance of the reception coil section 206a on account of the smaller distance to the measurement object 150. Consequently, V_{xb}<Vₓₐ arises, with the result that Vₓ=Vₓₐ−V_{xb}≠0. In this case, the amplitude of this reception voltage Vₓ corresponds to the distance or the displacement of the measurement object 150 in the x-direction relative to the reception coil 206.

This position sensor 200 therefore functions as a distance sensor, wherein at the reception coil 206 a reception voltage Vₓ is generated which is lower than the voltages Vₓₐ and V_{xb} respectively generated at the reception coil sections 206a and 206b and which contains information about the relative position of the measurement object 150 in a distance direction (x-direction) with respect to the reception coil 206. In this case, too, it holds true that the ratio of reception signal (reception voltage Vₓ) to transmission signal (transmission voltage Vₜ) contains information about the relative position of the measurement object 150 with respect to the reception coil 206.

The arrangement of the position sensor 200 in a housing can be implemented similarly to the arrangement of the position sensor 100 in accordance with the first embodiment as shown in FIG. 2. Consequently, with the second embodiment, too, it is possible to achieve a compact and flat position sensor 200 which is suitable in particular for use in high vacuum, e.g. in EUV lithography apparatuses.

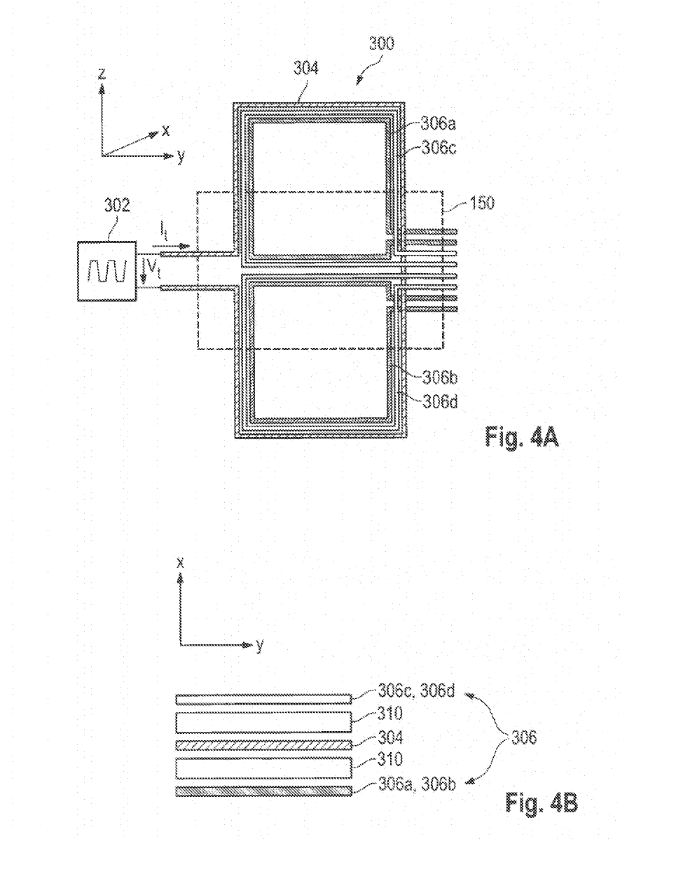

The concept underlying the third embodiment is to combine features of the coil arrangements of the first and second embodiments with one another. FIG. 4A schematically shows an exemplary arrangement of the transmission coil 304 and of the reception coil arrangement 306 in accordance with such a third embodiment. FIG. 4B schematically shows the sequence of the layers of the transmission coil 304 and of the reception coil arrangement 306 on and in a printed circuit board. Unless explained otherwise, the drive device 302, the transmission coil 304 and the reception coil arrangement 306 functionally and structurally correspond to the drive device 102, the transmission coil 104 and the reception coil 106 of the first embodiment, and primarily the differences between these embodiments are discussed below.

In the embodiment illustrated in FIG. 4A, too, the transmission coil 304 comprises a looped conductor track connected to the drive device 302 at both of its ends. The reception coil arrangement 306 comprises a first reception coil section 306a, a second reception coil section 306b, a third reception coil section 306c and a fourth reception coil section 306d.

In this case, the reception coil sections 306a and 306c can have approximately the same extent as viewed from above, that is to say are illustrated in a manner nested one in the other only for illustrative reasons in FIG. 4A. Furthermore, the reception coil sections 306b and 306d can also have approximately the same extent as viewed from above. The same correspondingly also applies to the embodiments discussed below. The reception coil sections 306a and 306c have approximately half of the extent of the transmission coil 304 and are arranged on one side of the substantially rectangular transmission coil 304. The reception coil sections 306b and 306d also have approximately half of the extent of the transmission coil 304 and are arranged on the other side of the transmission coil 304. The reception coil sections 306a and 306b are arranged in one plane below the transmission coil 304 parallel thereto. The reception coil sections 306c and 306d are arranged in one plane above the transmission coil 304 parallel thereto. In this embodiment, the transmission coil 304 is arranged within the printed circuit board, between the two insulating layers 310.

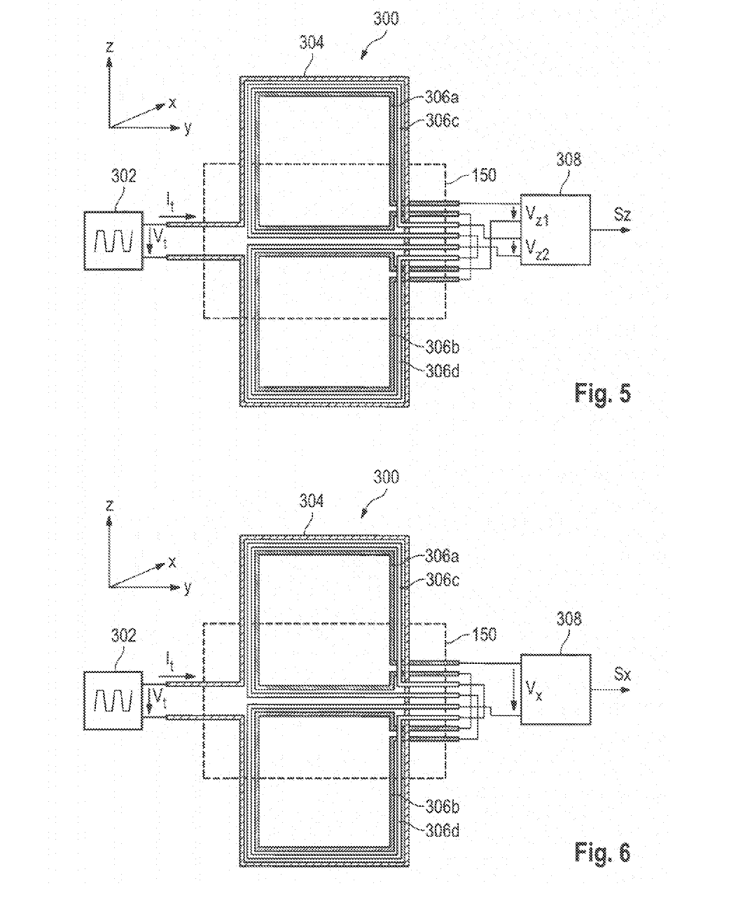

With this arrangement of transmission coil 304 and reception coil sections 306a-306d, position sensors 300 which function as a shear sensor or as a distance sensor can be realized in a simple manner. The fact of whether a position sensor 300 functions as a shear sensor or as a distance sensor depends in this case on the connection of the ends of the reception coil sections 306a-306d. This is explained with reference to FIGS. 5 and 6.

FIG. 5 schematically shows an exemplary arrangement of the transmission coil 304 and of the reception coil arrangement 306 in a position sensor 300 interconnected as a shear sensor. A first end of the first reception coil section 306a is connected to the evaluation device 308. A second end of the first reception coil section 306a is connected to a first end of the second reception coil section 306b. A second end of the second reception coil section 306b is connected to the evaluation device 308. A voltage V_{z1} is present between the first end of the first reception coil section 306a and the second end of the second reception coil section 306b, the voltage being fed to the evaluation device 308. A first end of the third reception coil section 306c is connected to the evaluation device 308. A second end of the third reception coil section 306c is connected to a first end of the fourth reception coil section 306d. A second end of the fourth reception coil section 306d is connected to the evaluation device 308. A voltage V_{z2} is present between the first end of the third reception coil section 306c and the second end of the fourth reception coil section 306d, the voltage being fed to the evaluation device 308. The first reception coil section 306a and the second reception coil section 306b and also the third reception coil section 306c and the fourth reception coil section 306d are in each case connected in antiseries with one another and therefore in each case correspond topologically to the reception coil sections 106a and 106b in FIG. 1A. Consequently, the voltages V_{z1} and V_{z2}. is in each case dependent on the displacement of the measurement object 150 in a shear direction (z-direction). Two voltages each containing information about the displacement of the measurement object 150 in a shear direction are therefore fed to the evaluation device 308. The evaluation device 308 can process these two voltages further (this further processing is described in detail further below) and then generate a sensor signal Sz as average value of the signals that have been processed further, the sensor signal representing the displacement of the measurement object 150 in a shear direction. Via this averaging, for example, production-dictated inaccuracies in the layout of the conductor tracks are compensated for and an even more accurate position measurement is thus made possible.

In a further development of the position sensor 300 in FIG. 5, it is possible to detect the position of the measurement object 150 both in the x-direction and in the z-direction and to carry out a compensation of the z-sensor signal in accordance with the x-position of the measurement object 150 via the sensor signals being electronically added and subtracted. The position of the reception coil sections 306a, 306b and 306c, 306d on different x-planes is utilized for this purpose.

FIG. 6 schematically shows an exemplary arrangement of the transmission coil 304 and of the reception coil arrangement 306 in a position sensor 300 interconnected as a distance sensor. A first end of the first reception coil section 306a is connected to the evaluation device 308. A second end of the first reception coil section 306a is connected to a first end of the second reception coil section 306b. A second end of the second reception coil section 306b is connected to a first end of the third reception coil section 306c. A second end of the third reception coil section 306c is connected to a first end of the fourth reception coil section 306d. A second end of the fourth reception coil section 306d is connected to the evaluation device 308. Proceeding from the evaluation device 308, in this case the direction of rotation of the first reception coil section 306a and of the second reception coil section 306a is in the counterclockwise direction, and the direction of rotation of the third reception coil section 306c and of the fourth reception coil section 306d is in the clockwise direction. Consequently, the first reception coil section 306a is connected in series with the reception coil section 306b, the third reception coil section 306c is connected in series with the fourth reception coil section 306d, and the first and second reception coil sections 306a and 306b are connected in antiseries with the third and fourth reception coil sections 306c and 306d.

The first reception coil section 306a and the second reception coil section 306b are arranged in the same plane, spatially parallel to the transmission coil 304, and together form a reception coil section which corresponds topologically to the reception coil section 206a in FIG. 3A. The third reception coil section 306c and the fourth reception coil section 306d are also arranged on the same plane, spatially parallel to the transmission coil 304 but on the opposite side from the reception coil sections 306a and 306b, and together form a reception coil section which corresponds topologically to the reception coil section 206b in FIG. 3A. This combination of the reception coil sections 306a and 306b is in turn connected in antiseries with the combination of the reception coil sections 306c and 306d, thus resulting in an arrangement and functionality corresponding to that in FIG. 3A. The voltage fed to the evaluation device 308 thus contains information about the displacement of the measurement object 150 in a distance direction (x-direction).

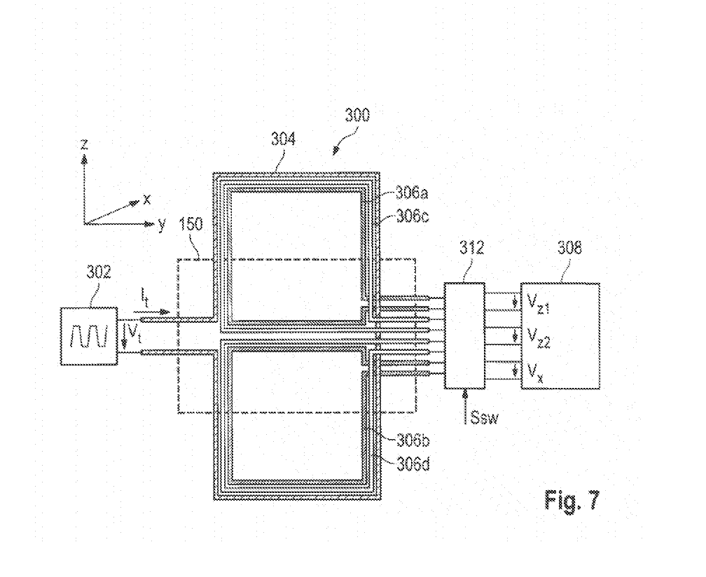

As is evident from FIGS. 5 and 6, in the case of the coil arrangement in FIG. 4A the fact of whether the position sensor can be operated as a shear sensor or as a distance sensor depends only on the interconnection of the reception coil section. FIG. 7 shows a variant of the position sensor 300 in accordance with the third embodiment, which can optionally be operated as a shear sensor or as a distance sensor. For this purpose, the position sensor 300 is additionally provided with a switch element 312, which is provided between the reception coil arrangement 306 and the evaluation device 308. A switch signal Ssw can be fed to the switch element 312 externally, the switch signal determining the switch position of the switch element 312. In a first switch position, the ends of the reception coil sections 306a to 306d are connected to one another or to the evaluation device 308 in such a way that an arrangement corresponding to FIG. 5 arises, such that the position sensor 300 can be operated as a shear sensor. In a second switch position, the ends of the reception coil sections 306a to 306d are connected to one another or to the evaluation device 308 in such a way that an arrangement corresponding to FIG. 6 arises, such that the position sensor 300 can be operated as a distance sensor. A space- and resource-saving position sensor 300 which can optionally be operated as a shear sensor or as a distance sensor can be provided in this way. In this case, it is possible periodically to change over the operating mode. However, it is also possible to set the operating mode once at start-up. Furthermore, it is possible to operate the position sensor 300 basically as a shear sensor, and to operate it as a distance sensor only for a short duration at specific intervals, the distance sensor signal determined being used for calibrating or correcting the shear sensor signal. In an alternative embodiment, it is also possible for the signals at the reception coils to be electronically added and/or subtracted, instead of being fed to the evaluation device 308 via the switch element 312.

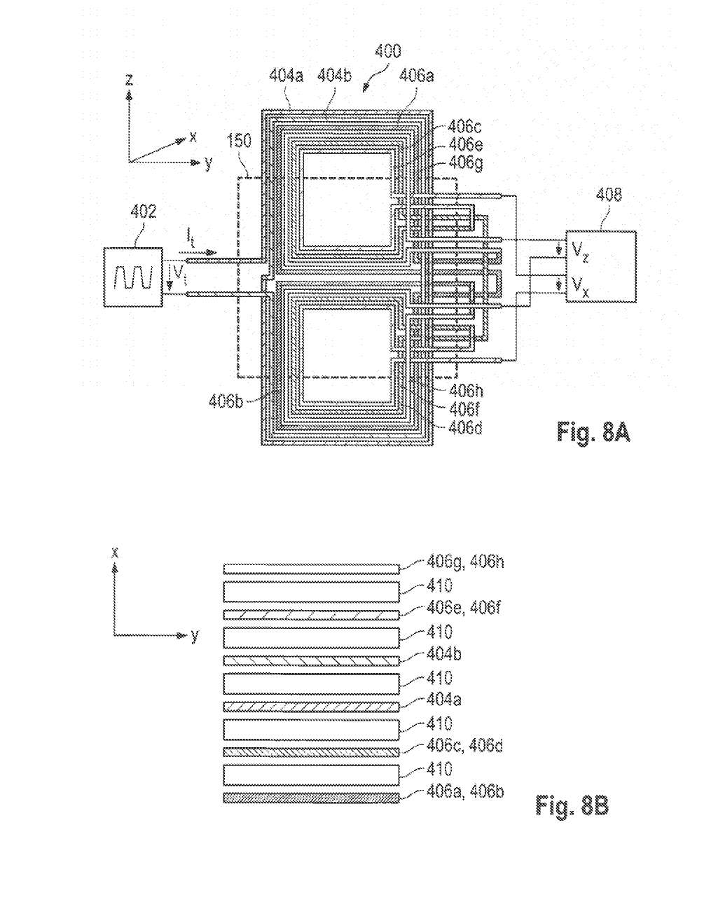

A position sensor 400 in accordance with a fourth embodiment is explained below with reference to FIGS. 8A and 8B, the position sensor comprising a drive device 402, a transmission coil 404, a reception coil arrangement 406 and an evaluation device 408. FIG. 8A schematically shows an exemplary arrangement of the transmission coil 404 and of the reception coil arrangement 406. FIG. 8B schematically shows the sequence of the layers of the transmission coil 404 and of the reception coil arrangement 406 on and in a printed circuit board. Unless explained otherwise, the drive device 402, the transmission coil 404, the reception coil arrangement 406 and the evaluation device 408 correspond functionally and structurally to the corresponding elements of the embodiments described above, and primarily the differences in relation to the embodiments are discussed below.

In the embodiment illustrated in FIG. 8A, too, the transmission coil 404 comprises a looped conductor track connected to the drive device 402 at both of its ends. In contrast to the embodiments described above, however, the transmission coil 404 has two transmission coil sections 404a and 404b, which form two coil windings and are arranged on different parallel planes of the printed circuit board. The reception coil arrangement 406 comprises eight reception coil sections 406a to 406h, which are arranged on four different planes of the printed circuit board in a manner separated by insulating layers 410. In this case, two of the reception coil sections 406a to 406h are respectively arranged in one plane and each of the reception coil sections 406a to 406h has an area extent corresponding approximately to half of the area extent of the transmission coil 404. To put it more precisely, the reception coil sections 406a and 406b are arranged on the bottommost plane, the reception coil sections 406c and 406d are arranged on the second from bottom plane, the transmission coil section 404a is arranged on the third from bottom plane, the transmission coil section 404b is arranged on the fourth from bottom plane, the reception coil sections 406e and 406f are arranged on the second from top plane, and the reception coil sections 406g and 406h are arranged on the topmost plane of the printed circuit board.

The reception coil sections 406a to 406h are interconnected to form two reception coils. Specifically, the reception coils 406a, 406b, 406g and 406h are interconnected to form a first reception coil in such a way that a voltage V_{z} is generated at the reception coil during operation, the voltage containing information about a displacement of the measurement object 150 in a shear direction (z-direction) and being fed to the evaluation device 408. In this case, the reception coil sections 406a and 406g are interconnected in series with one another in a manner overlapping one another with the same winding direction in different planes of the printed circuit board, that is to say can also be regarded as individual coil windings of this first reception coil. The same applies to the reception coil sections 406b and 406h. In this case, the reception coil sections 406b and 406h are connected in antiseries with the reception coil sections 406a and 406g, that is to say with the opposite winding direction, thus resulting in the functionality explained for the first embodiment.

Furthermore, the reception coil sections 406c, 406d, 406e and 406f are interconnected to form a second reception coil in such a way that a voltage Vₓ is generated at the reception coil during operation, the voltage containing information about a displacement of the measurement object 150 in a distance direction (x-direction) and being fed to the evaluation device 408. In this case, the reception coil sections 406a and 406g are interconnected in series with one another in a manner overlapping one another in different planes of the printed circuit board. The same applies to the reception coil sections 406b and 406h. Furthermore, the reception coil sections 406c and 406e (and 406d and 406f) arranged in different planes have different winding directions and the reception coil sections 406c and 406d (and 406e and 406f) arranged in the same plane have the same winding direction in each case. This results in an arrangement which corresponds to the position sensor in accordance with the second embodiment, with corresponding functionality. This second reception coil therefore likewise comprises reception coil sections which are arranged on different planes of the printed circuit board, on different sides of the transmission coil 404.

The voltages Vₓ and V_{z} present at the first and the second reception coils consisting of the reception coil sections 406a to 406h are fed to the evaluation device 408 and processed further by the latter. Consequently, the position sensor 404 can detect displacements of the measurement object with respect to two degrees of freedom, namely in the x-direction and z-direction. Furthermore, this position sensor 400 is also compact and flat and suitable in particular for use in high vacuum, e.g. in EUV lithography apparatuses.

In this case, the transmission coil 404 of the position sensor 400 has two coil windings, and the two reception coils of the reception coil arrangement 406 also have double coil windings in each case. Consequently, the inductance of the transmission coil 404 and of the reception coil arrangement 406 is greater than in the case of single windings. To put it another way, it is thus possible to create coils having the same inductance with a smaller area requirement, such that an even more compact position sensor is made possible with this embodiment.

It should be clear that the arrangements described above are merely by way of example. In particular, the transmission coil and the reception coils can be provided with further winding planes in order to increase their inductance further.

In the case of the above-described position sensor 100 in accordance with the first embodiment, the amplitude of the reception voltage V_{z} or the output signal of the evaluation device 108 is dependent on the distance between the reception coil 106 and the measurement object 150. To put it more precisely, the amplitude of the reception voltage V_{z} decreases with increasing distance of the measurement object 150 in the x-direction. The position sensor 100 is therefore sensitive not only in the z-direction, but also in the x-direction. This is unimportant if the distance of the measurement object 150 in the x-direction is known and in particular invariable (e.g. by virtue of a corresponding mounting), such that a corresponding calibration is possible. However, if the position of the measurement object 150 with respect to the z-direction and the x-direction is unknown or variable, then measures are required in order to compensate for or correct the dependence of the output signal on the distance of the measurement object 150 in the x-direction. Such measures are discussed below.

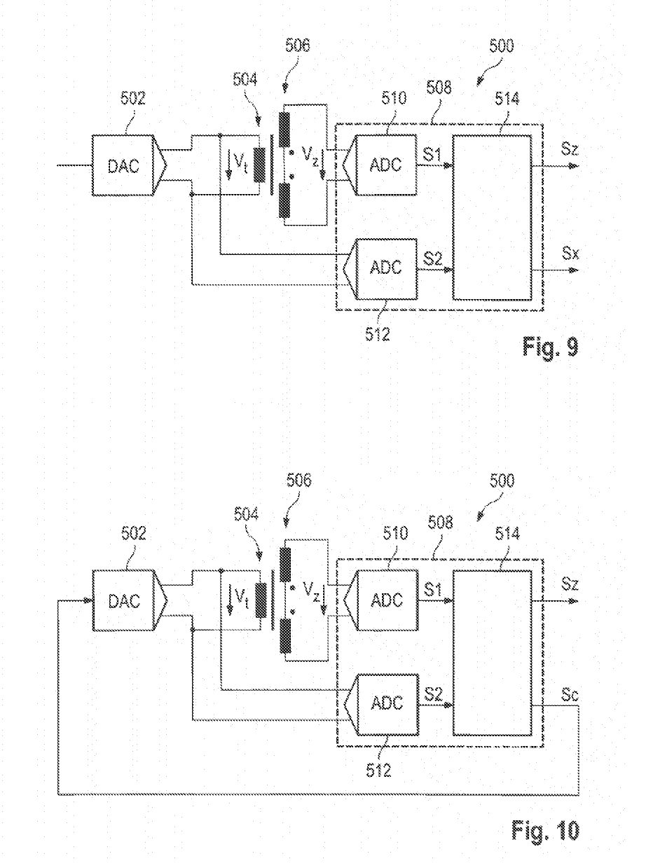

FIG. 9 shows a position sensor 500 in accordance with a fifth embodiment.

In the embodiments explained above, the focus was on the arrangement of the coils, whereas in this fifth embodiment, and the following embodiments, the focus is on the drive and evaluation electronics. The coil arrangement of the sensor is illustrated as a transformer in FIG. 9 (and also in the figures of the following embodiments), comprising a primary winding (transmission coil 504) and two antiseries-connected secondary windings (reception coil 506), the transformer transferring the non-DC components of a transmission signal. The coupling between the primary winding and the secondary windings depends in this case on the position of the movable measurement object, which is represented schematically by the transformer core in the figures. The position sensor 500 in accordance with this fifth embodiment, too, therefore comprises a drive device 502, a transmission coil 504, a reception coil 506 and an evaluation device 508. In this case, the drive device 502 is designed as a digital-to-analog converter (DAC) that converts a digital input signal into an analog transmission signal, a transmission current in the present case.

The alternating transmission current generated by the drive device 502 generates a voltage Vₜ at the transmission coil 504, which voltage, in the case of a predetermined amplitude of the transmission current, correlates with the distance of the measurement object 150 in the x-direction, that is to say in other words represents a measure of the distance of the measurement object 150. By contrast, the ratio V_{z}/Vₜ between the output voltage V_{z} present at the reception coil and the voltage Vₜ at the transmission coil 504 is a measure of the displacement of the measurement object 150 in the z-direction. Although this output voltage V_{z} also depends on the distance of the measurement object 150 in the x-direction, this dependence can be compensated for by adding the voltage Vₜ, as will also be explained further below.

The transmission coil 504 can be designed like each of the transmission coils from the embodiments described above. In principle, the reception coil 506 can be designed like each of the reception coils from the embodiments described above, and can be designed in particular as a reception coil which responds to a displacement of the measurement object (not illustrated in FIG. 9) in a shear direction (that is to say in the z-direction), that is to say for example the reception coil arrangement 106 in FIGS. 1 and 2, the reception coil arrangement 306 in FIGS. 4 to 7, the reception coil arrangement 406 in FIG. 8, or the reception coil arrangement 506 in FIG. 9.

The evaluation device 508 comprises a first analog-to-digital converter 510, a second analog-to-digital converter 512 and a digital signal processing device 514. The first analog-to-digital converter 510 receives the analog reception voltage (e.g. V_{z}) present at the reception coil 506 and converts it into a digital signal S1, which is fed to the signal processing device 514. The second analog-to-digital converter 512 receives the analog transmission voltage Vₜ present at the transmission coil 504 on the input side and converts it into a digital signal S2, which is fed to the signal processing device 514. The analog-to-digital converters 510, 512 can be operated for example with a sampling rate that corresponds to the frequency of the transmission voltage Vₜ, as a result of which a demodulation of the alternating reception voltage is simultaneously achieved.

The reception coil 506 can be designed to respond to a displacement of the measurement object in a shear direction (that is to say in the z-direction), such that the output voltage V_{z} at the reception coil arrangement, and thus also the output signal S1 of the first analog-to-digital converter 510, is dependent on the position of the measurement object in a shear direction (z-direction) relative to the reception coil 506. Furthermore, the analog transmission voltage Vₜ at the reception coil 504 depends on the position of the measurement object in a distance direction (x-direction) relative to the reception coil 506. To put it more precisely, the self-inductance of the transmission coil 504 varies in a manner dependent on the distance between the measurement object and the transmission coil 504. This principle is used in eddy current sensors, for example: in this case, the transmission coil is part of a resonant circuit, for example, and the change in the resonant frequency or the damping of the resonant circuit can serve as a measure of position or the distance of the measurement object.

On the input side, a resonant circuit (not illustrated in more specific detail in FIG. 9) can be provided upstream of the transmission coil 504, which resonant circuit can be embodied as a series resonator or a parallel resonator. With the aid of such a resonant circuit, the voltage at the transmission coil 504 can be increased, such that a voltage source having a low voltage can be used. Furthermore, a resonant circuit (not illustrated in more specific detail in FIG. 9) can also be provided downstream of the reception coil 506, for the purpose of improving the noise response.

If the drive device 502 feeds a predetermined current to the transmission coil 504, then the digital signal S2 generated by the second analog-to-digital converter 512 is dependent on the distance of the measurement object (in the x-direction). The signal processing device 514 processes further the signals fed to it and outputs a sensor signal Sz, for example, which represents the displacement of the measurement object in a shear direction (z-direction). It is furthermore possible for the signal processing device 514 additionally also to output a sensor signal Sx representing the displacement of the measurement object in a distance direction (x-direction). The digital signal processing device 514 can be designed as a microprocessor or the like, for example, and can be program-controlled, in particular.

As already explained above, the reception voltage V_{z} at the reception coil arrangement 506 depends not only on the displacement of the measurement object in a shear direction (z-direction) but also on the displacement of the measurement object in a distance direction (x-direction). In accordance with the present fifth embodiment, the signal processing device 514 utilizes the signal S2 containing information about the displacement of the measurement object 150 in a distance direction (x-direction) in order to correct the sensor signal Sz or to compensate for the influence of the distance of the measurement object 150 on the z-position measurement.

In a first variant, the signal processing device 514 calculates the sensor signal Sz as a cross-correlation of the signals S1 and S2 divided by the autocorrelation of the signal S2. A corrected signal Sz that is normalized to the input variable, that is to say the voltage at the transmission coil 104, is thus generated.

In a second variant, the signal processing device 514 comprises a look-up table, to which the values of the digital signals S1 and S2 are fed as input variables. The two signals S1 and S2 are actually dependent in each case on the position of the measurement object with respect to the position sensor 500. However, a unique assignment between the values of the signals S1 and S2 and the actual positions of the measurement object with respect to the position sensor 500 prevails at least in regions. The look-up table thus assigns to the values of the signals S1 and S2 output values which represent the z- and x-positions of the measurement object, and the signal processing device 514 outputs corresponding sensor signals Sz and Sx. It goes without saying that it is also possible that, with the aid of the look-up table, the z-value is corrected and the signal processing device 514 only outputs a corresponding sensor signal Sz corrected with respect to the x-displacement.

With the position sensor 500 in accordance with the fifth embodiment as described here, the sensor signal Sz representing a displacement of the measurement object in a shear direction (z-direction) can be corrected in a simple manner with regard to changes in distance with respect to the measurement object. In this case, it is possible to detect displacements of the measurement object with respect to two spatial directions with a compact sensor arrangement. Furthermore, the position sensor 500 in accordance with the fifth embodiment has an excellent temperature stability since the latter depends principally on the DAC and the ADCs. Furthermore, the advantages explained in connection with the first four embodiments can also be achieved. In particular, it is possible to accommodate the drive device 502, the coils 504 and 506 and the evaluation device 508 on a single printed circuit board or in a compact printed circuit board assemblage (cf. FIG. 2).

It should be noted that, in the embodiment described above, the drive device 502 is embodied with a DAC as current source. Consequently, a predetermined current as transmission signal is fed to the transmission coil 504 and the voltage Vₜ present at the transmission coil 504 depends on the distance of the measurement object in the x-direction. As an alternative thereto, however, it is also possible to embody the drive device 502 as a voltage source, such that a predetermined voltage as transmission signal is fed to the transmission coil 504. In this case, the current flowing through the transmission coil 504 is dependent on the distance of the measurement object in the x-direction, and can thus be used as a measure of the distance and for the compensation of the sensor signal for the shear direction. It holds true in both cases, however, that the ratio of reception signal to transmission signal contains information about the relative position of the measurement object with respect to the reception coil.

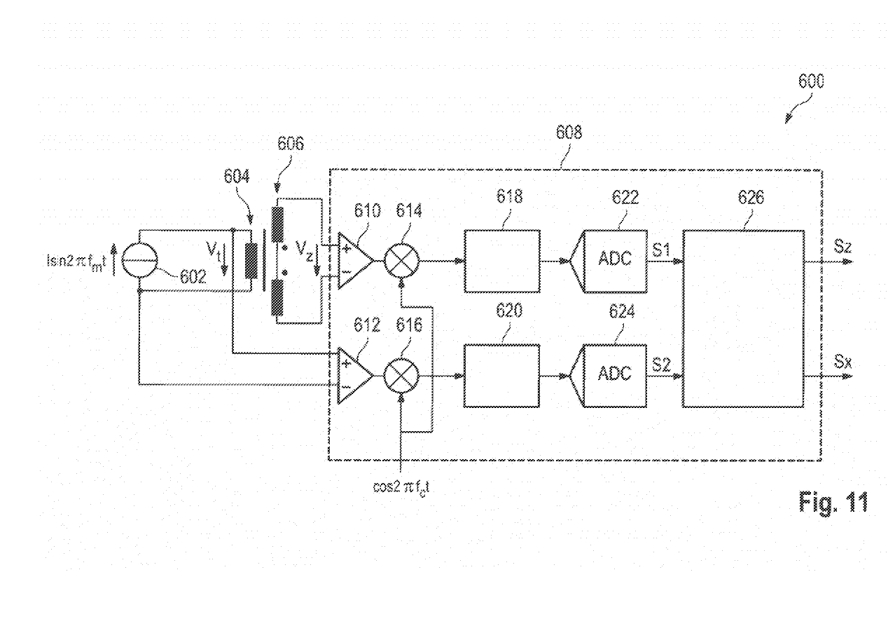

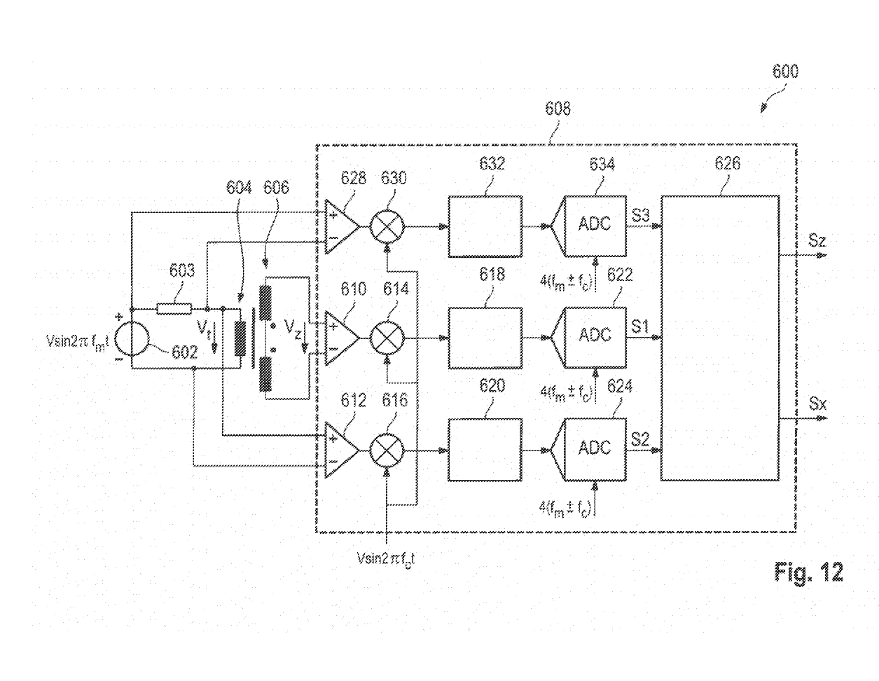

In a third variant of the fifth embodiment, which is illustrated in FIG. 10, the signal processing device 514 generates a control signal Sc on the basis of the information about the distance of the measurement object in the x-direction, the control signal being fed to a control input of the digital-to-analog converter 502. Depending on this control signal Sc, the digital-to-analog converter 502 varies e.g. the amplitude of the transmission current (transmission signal) output by it. Consequently, an input-side adaptation of the transmission power to the distance in the x-direction with respect to the measurement object is effected, such that the sensor signal Sz can be correspondingly corrected.

A precise position sensor 500 can be realized with the fifth embodiment described above. However, operation at high frequencies and with high resolution requires DACs, ADCs and differential amplifiers which are operated at high speed and thus have a comparatively high power consumption.

FIG. 11 shows a position sensor 600 in accordance with a sixth embodiment. The position sensor 600 in accordance with this sixth embodiment also comprises a drive device 602, a transmission coil 604, a reception coil 606 and an evaluation device 608, which correspond to the elements described above, unless indicated otherwise. In this case, the drive device 602 is designed as a current source that generates an AC current I sin 2πfₘt.

The evaluation device 608 comprises two differential amplifiers 610, 612, two mixers 614, 616, two filters 618, 620, two analog-to-digital converters 622 and 624, and a digital signal processing device 626. The differential amplifier 610 amplifies the reception voltage present at the reception coil 606. The signal amplified by the differential amplifier 610 is demodulated with the aid of the mixer 614 by being multiplied by a signal proportional to cos 2πf_{c}t. This demodulated signal is filtered with the aid of the filter 618, which is embodied as a low-pass filter or as a bandpass filter, and the signal obtained is converted into a digital signal S1 with the aid of the analog-to-digital converter 622 and fed to the signal processing device 626. As described for the fifth embodiment, this output signal S1 of the first analog-to-digital converter 622 is dependent on the position of the measurement object in a shear direction (z-direction) relative to the reception coil 606.

Furthermore, the differential amplifier 612 amplifies the reception voltage present at the transmission coil 604. The signal amplified by the differential amplifier 612 is demodulated with the aid of the mixer 616 by being multiplied by a signal proportional to cos 2πf_{c}t. This demodulated signal is filtered with the aid of the filter 620, which is embodied as a low-pass filter or as a bandpass filter, and the signal obtained is converted with the aid of the analog-to-digital converter 624 into a digital signal S2 and fed to the signal processing device 626. As described for the fifth embodiment, this output signal S2 of the second analog-to-digital converter 624 is dependent on the position of the measurement object in a distance direction (x-direction) relative to the reception coil 606.

The signal processing device 626 processes the signals S1 and S2 fed to it, e.g. in the manner described for the fifth embodiment, and outputs sensor signals Sz and/or Sx representing the position of the measurement object relative to the position sensor 600.

The position sensor 600 in accordance with the sixth embodiment thus differs from the position sensor 500 in accordance with the fifth embodiment in that firstly a demodulation of the reception voltage and of the transmission voltage takes place in each case before the demodulated signals are digitized. A so-called “down-conversion system” is therefore involved here. Consequently, the evaluation device 608 can be realized with components of lower power. Furthermore, the position sensor 600 in accordance with the sixth embodiment is more robust in relation to noise, in particular low-frequency noise. Furthermore, the position sensor 600 likewise has an excellent temperature stability.

If the sensor coils behave purely inductively, then a direct conversion system requires that f_{c}=fₘ, where fₘ is the frequency of the transmission current and f_{c} is the frequency of the demodulation signal. In order thus to achieve a precise detection of the x-position of the measurement object, the amplitude of the transmission current has to be known, which can require a known AC source. Otherwise, it is not possible to distinguish fluctuations in the AC source from fluctuations in the position of the measurement object. If the AC source is not known sufficiently, a further ADC channel can be established in order to detect the transmission current. This is explained on the basis of the further development of the position sensor 600 in accordance with the sixth embodiment as illustrated in FIG. 12.

The position sensor 600 in accordance with this further development differs from the position sensor 600 shown in FIG. 11 by virtue of an additional ADC channel having a further differential amplifier 628, a mixer 630, a filter 632 and an analog-to-digital converter 634. Furthermore, in the case of this position sensor 600, the drive device 602 is designed as a voltage source that outputs an AC voltage V sin 2πfₘt. A resistor 603 is provided between the drive device 602. The voltage dropped across the resistor 603 is proportional to the transmission current Iₜ through the transmission coil 604. The voltage is tapped off and amplified by the differential amplifier 628. The signal amplified by the differential amplifier 628 is demodulated with the aid of the mixer 630 by being multiplied by a signal proportional to V sin 2πf_{c}t. This demodulated signal is filtered with the aid of the filter 632, which is embodied as a low-pass filter or as a bandpass filter, and the signal obtained is converted into a digital signal S3 with the aid of the analog-to-digital converter 634 and fed to the signal processing device 626. The signal S3 is phase-shifted substantially by 90 degrees relative to the signal S1 since the signal S1 is derived from the transmission voltage Vₜ at the transmission coil 604 and the signal S3 is derived from the transmission current Iₜ through the transmission coil 604. Furthermore, this signal S3 once again corresponds to the transmission current Iₜ through the transmission coil 604. Via a suitable signal processing with the signal processing device 626, therefore, it is possible to obtain a stable signal Sx which corrects fluctuations in the drive current or the drive voltage. By way of example, here as well the signal processing device 626 can form a corrected signal from the cross-correlation of the signals S1 and S3 divided by the autocorrelation of the signal S3. The further processing in the signal processing device 626, e.g. with regard to the correction of the signal Sz for the displacement of the measurement object in a shear direction, can be effected in the manner described for the other embodiments.

Furthermore, f_{c}≠fₘ can hold true in this further development. Consequently, a displacement of the measurement object in a distance direction (x-direction) is detected with the aid of a quadrature detection, wherein transmission voltage and current and reception voltage are firstly down-modulated to an intermediate frequency. This intermediate frequency should be at least double the bandwidth of the position sensor 600, that is to say e.g. fₘ−f_{c}≧20 [kHz] for f_{c}<fₘ and f_{c}−fₘ≦20 [kHz] for f_{c}>fₘ.

With this further development of the sixth embodiment, the advantages of a quadrature detection, that is to say e.g. greater robustness relative to interference, can be achieved in addition to the advantages mentioned above.

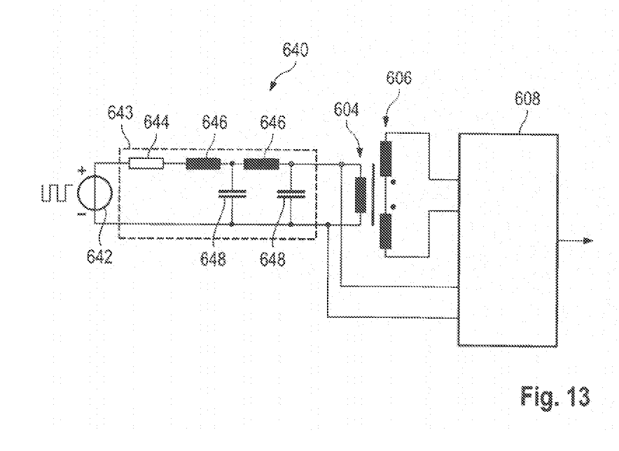

FIG. 13 shows one possible embodiment of the drive device 640 of the position sensor 600 in accordance with the sixth embodiment. This drive device 640 comprises a digital signal source 642 and an impedance matching network 643. The impedance matching network 643 can comprise, for example, a resistor 644, two coils 646 and two capacitors 648, although there is no restriction thereto and numerous other arrangements are also possible. The two coils 646 are arranged in series with the transmission coil 604 and the two capacitors 648 are arranged in parallel with the transmission coil 604.

The digital signal source 642 outputs a pulsed signal. Since the coils and 646 and capacitors 648 form a low-pass filter, this pulsed signal is converted into a sinusoidal transmission signal. Furthermore, the coils and 646 and capacitors 648 together with the transmission coil 604 form a resonant circuit having a predetermined resonant frequency. If the signal source 642 is operated close to this resonant frequency, the reactive power that is output can then be reduced.

In a modification of this variant, it is also possible for the input-side impedance matching network comprising the resistor 644, the coils 646 and the capacitors 648 to be matched in a manner dependent on an output signal of the evaluation device 608. By way of example, one of the capacitors 648 can be designed as a variable capacitor that can be adjusted in a manner dependent on an output signal. If the evaluation device 608 then provides an output signal whose level depends on the distance of the measurement object 150 in the z-direction, a correction of the level of the transmission current Iₜ can thus be achieved, and the influence of the distance of the measurement object 150 in the z-direction on the measurement of the position of the measurement object 150 in the shear direction can be suppressed.

It should be noted that the embodiments described above are merely by way of example and can be varied diversely in the context of the scope of protection of the patent claims. In particular, the features of the embodiments described above can also be combined with one another.

In this regard, by way of example, in the embodiments described above, the conductor tracks which connect the transmission coils and the reception coil arrangements to the drive and evaluation orientation proceed from the longitudinal sides thereof. However, it is also possible for these connecting conductor tracks to proceed from the shorter sides of the coils. This has the advantage that a more symmetrical arrangement can be achieved in the region situated opposite the measurement object.

### LIST OF REFERENCE SIGNS

100 position sensor
102 drive device
104 transmission coil
106 reception coil
106a, 106b reception coils
108 evaluation device
110 insulating layer
112 housing
114 window
120 first printed circuit board
122 second printed circuit board
124 metal film
150 measurement object
152 frame element
154 structural element
200 position sensor
202 drive device
204 transmission coil
206 reception coil
206a, 206b reception coils
208 evaluation device
210 insulating layer
300 position sensor
302 drive device
304 transmission coil
306 reception coil arrangement
306a, 306b reception coils
308 evaluation device
310 insulating layer
312 switch element
400 position sensor
402 drive device
404 transmission coil
406 reception coil arrangement
406a-406h reception coils
408 evaluation device
410 insulating layer
500 position sensor
502 drive device
504 transmission coil
506 reception coil arrangement
508 evaluation device
510 first analog-to-digital converter
512 second analog-to-digital converter
514 digital signal processing device
600 position sensor
602 drive device
603 resistor
604 transmission coil
606 reception coil arrangement
608 evaluation device
610, 612 differential amplifier
614, 616 mixer
618, 620 filter
622, 624 analog-to-digital converter
626 digital signal processing device
628 differential amplifier
630 mixer
632 filter
634 analog-to-digital converter
640 drive device
642 digital signal source
643 impedance matching network
644 resistor
646 coils
648 capacitors

1.-24. (canceled)

25. An apparatus, comprising:
a position sensor, comprising:
a transmission coil;
a reception coil configured so that, when a transmission signal is applied to the transmission coil during use of the position sensor, a reception voltage is generated at the reception coil; and
an evaluation device configured so that, during use of the position sensor, the evaluation device: a) links a transmission voltage signal with a reception voltage signal; and b) generates a sensor output signal containing information about a position of a measurement object of the apparatus relative to the transmission and reception coils,
wherein:
the position sensor is configured so that during use of the position sensor:
the transmission voltage signal is generated in a manner dependent on the transmission signal; and
the reception voltage signal is generated in a manner dependent on the reception voltage; and
the apparatus is a lithography apparatus.

26. The apparatus of claim 25, wherein the measurement object comprises an optical element.

27. The apparatus of claim 25, wherein the evaluation device comprises:
a first analog-to-digital converter configured so that, during use of the position sensor, the first analog-to-digital converter converts the voltage generated at the reception coil or an analog signal derived therefrom into a digital signal; and
a second analog-to-digital converter configured so that, during use of the position sensor, the second analog-to-digital converter converts the voltage present at the transmission coil or an analog signal derived therefrom into a digital signal.

28. The apparatus of claim 25, wherein the evaluation device is configured so that, during use of the position sensor, the evaluation device forms a cross-correlation of the transmission voltage signal with the reception voltage signal.

29. The apparatus of claim 25, wherein the evaluation device comprises a memory comprising a look-up table assigning values of the transmission voltage signal and values of the reception voltage signal to an output value representing a position of the measurement object relative to the position sensor.

30. The apparatus of claim 25, wherein the position sensor further comprises a drive device configured so that, during use of the position sensor, the drive device applies an alternating transmission signal to the transmission coil.

31. The apparatus of claim 30, wherein the drive device is configured so that, during use of the position sensor, the drive device varies the transmission signal in a manner dependent on a sensor output signal.

32. The apparatus of claim 30, wherein the drive device comprises an impedance matching network.

33. The apparatus of claim 32, wherein the impedance matching network comprises a capacitor which is adjustable in a manner dependent on the sensor output signal.

34. The apparatus of claim 25, wherein the position sensor further comprises a plurality of position sensors alongside each other.

35. The apparatus of claim 34, wherein the position sensor is configured so that, during use of the position sensor, transmission signals having different frequencies are applied to adjacent position sensors.

36. The apparatus of claim 25, wherein the measurement object comprises a mirror.

37. The apparatus of claim 25, wherein:
the position sensor further comprises a plurality of reception coil sections and a switch element having first and second positions;
the reception coil sections are interconnected to define a first reception coil in the first switch position so that, during use of the position sensor, when a transmission signal is applied to the transmission coil, a first reception signal is generated at the first reception coil, and a ratio of the first reception signal to the transmission signal contains information about the position of the measurement object in a shear direction relative to the first reception coil; and
the reception coil sections are interconnected to define a second reception coil in the second switch position so that, during use of the position sensor, when a transmission signal is applied to the transmission coil, a second reception signal is generated at the second reception coil, and a ratio of the second reception signal to the transmission signal contains information about the position of the measurement object in a distance direction relative to the second reception coil.

38. A lithography apparatus, comprising:
a position sensor, comprising:
a printed circuit board;
a transmission coil arranged on a first plane of the printed circuit board; and
a reception coil arranged on a second plane of the printed circuit board which is parallel to but different from the first plane of the printed circuit board, the reception coil comprises first and second reception coil sections which are arranged in different parallel planes of the printed circuit board,
wherein:
the apparatus is a lithography apparatus; and
the transmission coil and the reception coil are arranged so that, during use of the position sensor, when a temporally variable transmission signal is applied to the transmission coil, a temporally variable reception signal is generated at the reception coil, and a ratio of reception signal to transmission signal contains information about a position of a measurement object of the apparatus relative to the reception coil;
the first and second reception coils section are connected so that, during use of the position sensor when the transmission signal is applied to the transmission coil, a reception voltage is generated at the reception coil, and the reception voltage corresponds to a difference between the voltage at the first reception coil section and the voltage at the second reception coil section; and
the first and second reception coil sections are connected together so that, during use of the position sensor, a transfer response of the transmission coil and the reception coil contains information about a position of the measurement object in a distance direction relative to the reception coil.

39. The apparatus of claim 38, wherein the first and second reception coil sections are arranged on different sides of the transmission coil.

40. The apparatus of claim 38, wherein the first and second reception coil sections are arranged so that, during use of the position sensor when a transmission voltage is applied to the transmission coil in the absence of the measurement object, substantially no voltage is present at the reception coil.

41. The apparatus of claim 38, wherein the first and second reception coil sections are substantially congruent with the transmission coil.

42. The apparatus of claim 38, wherein each of the first and second reception coils has half of an area extent of the transmission coil.

43. The apparatus of claim 38, wherein:
the position sensor comprises a first reception coil having a first reception coil section;
the position sensor comprises a second reception coil having a second reception coil section; and
the first and second reception coil sections are connected to each other so that, during use of the position sensor when the transmission signal is applied to the transmission coil, a reception signal is generated at each of the first and second reception coils, and a ratio of the reception signal to the transmission signal contains information about the position of the measurement object in a shear direction relative to the reception coil.

44. The apparatus of claim 43, wherein the first and second reception coils are arranged on different sides of the transmission coil.

45. The apparatus of claim 38, wherein the position sensor further comprises:
a drive device configured so that, during use of the position sensor, the drive device applies an alternating transmission signal to the transmission coil; and
an evaluation device configured so that, during use of the position sensor, the evaluation device evaluates the reception signal at the reception coil.

46. The apparatus of claim 45, wherein the drive device and the evaluation device are arranged on the same side of the printed circuit board as the transmission coil and the reception coil.

47. The apparatus of claim 45, wherein the position sensor comprises a second printed circuit board, the drive device and the evaluation device are arranged on the second printed circuit board, the printed circuit boards are connected to each other in a planar manner, and a metal film is arranged between the printed circuit boards.

48. The apparatus of claim 38, wherein the position sensor comprises first and second reception coils designed so that, during use of the position sensor when a transmission signal is applied to the transmission coil:
a first reception signal is generated at the first reception coil, and a ratio of the first reception signal to the transmission signal contains information about a position of the measurement object in a shear direction relative to the first reception coil; and
a second reception signal is generated at the second reception coil, and a ratio of the second reception signal to the transmission signal contains information about a position of the measurement object in a distance direction relative to the second reception coil.
